(19) United States
(12) Patent Application Publication
(10) Pub. No.: US 2009/0046928 A1
(43) Pub. Date: Feb. 19, 2009

(54) Auto white balance method

(75) Inventors: Boo Dong Kwak, Suwon (KR); Bong Soon Kang, Busan (KR); Sang Choon Kim, Busan (KR); Joo Young Ha, Changwon (KR); Kyoung Soo Son, Busan (KR); Hak Sun Kim, Daejeon (KR); Won Tae Choi, Yongin (KR); Joo Hyun Kim, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/222,660

(22) Filed: Aug. 13, 2008

(30) Foreign Application Priority Data
Aug. 14, 2007 (KR) 10-2007-0081696

(51) Int. Cl. G06K 9/03

(52) U.S. Cl. 382/167

(57) ABSTRACT

An auto white balance method includes converting a color space of an input image from an RGB color space into the Commission International de I'Eclairage (CIE) L*a*b* color space, determining at least a portion of pixels of the input image, assumed that a reference white color is changed, in a range of a predetermined L*a*b* value as pixels to be used for estimating the reference white color, determining averages of an L* value, an a* value, a b* value of the determined pixels to be used for estimating the reference white color as a reference white color estimation value, and calculating a color gain to move the reference white color estimation value to a target value for a predetermined white balance.

### CROSS-REFERENCE TO RELATED APPLICATIONS

This application claims the priority of Korean Patent Application No. 2007-81696, filed on Aug. 14, 2007, in the Korean Intellectual Property Office, the disclosure of which is incorporated herein by reference.

### BACKGROUND OF THE INVENTION

1. Field of the Invention

The present invention relates to digital image processing, and more particularly, to an auto white balance method using a Commission International de I'Eclairage (CIE) L*a*b* color space to estimate a reference white color changed by surrounding environments such as a light source.

2. Description of the Related Art

White balance refers to the adjustment of the relative amounts of colors such that colors of an image captured by an image capture unit (e.g., a digital image sensor) can maintain its original color without alteration caused by surrounding environments such as a light source. That is, if there is no white balance, an image of a white subject transferred from an image sensor may not be accurately expressed due to surrounding environments such as a light source.

In general, estimating of the degree of changes due to a light source through an obtained image from an image sensor for white balance is regarded as estimating of a reference white color. That is, what kinds of changes occur in a white portion of an image is estimated.

According to a typical estimation method, provided are a maximum red, green, and blue (RGB) method that estimates white color with reference to each maximum RGB value of an input image, a grayworld method that determines an average RGB value of an inputted color image as a gray color and then estimates a reference white color using the gray color, and a method of estimating a reference white color using a nerve network. A representative method of compensating for a color tone of a subject through the typical estimation method is to express an accurate white color from a distorted white color subject as by adjusting a color gain (i.e., a coefficient multiplied by each color information). These processes are called auto white balance. An image with respect to one subject, captured in a certain light source and processed by auto white balance, should have the same color tone as the original subject.

However, according to the typical reference white color estimation method, if only a specific portion of an image is extremely bright or a certain specific color in an image is greatly distributed, wrong white color is estimated such that a wrong color gain can be calculated in many cases. Therefore, there are limitations in achieving accurate auto white balance.

### SUMMARY OF THE INVENTION

An aspect of the present invention provides an accuracy improved auto white balance method through Commission International de I'Eclairage (CIE) L*a*b* color space (indicating image information by using brightness and chromaticity) in order to estimate a reference white color through pixel distribution based on L*, a*, and b* values.

According to an aspect of the present invention, there is provided auto white balance method including: converting a color space of an input image from an RGB color space into the Commission International de I'Eclairage (CIE) L*a*b* color space; determining at least a portion of pixels of the input image, assumed that a reference white color is changed, in a range of a predetermined L*a*b* value as pixels to be used for estimating the reference white color; determining averages of an L* value, an a* value, a b* value of the determined pixels to be used for estimating the reference white color as a reference white color estimation value; and calculating a color gain to move the reference white color estimation value to a target value for a predetermined white balance.

The converting of the color space may include: converting an RGB value that each pixel of the input image has into an XYZ value based on the CIE standard; and converting the converted XYZ value of each pixel into the L*a*b* value.

The converting of the RGB value into the XYZ value may be performed through Equation 1 below and the converting of the XYZ value into the L*a*b* value may be performed through Equation 2 below.

$$\begin{matrix}[ \begin{matrix}X \\ Y \\ Z\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] \times [ \begin{matrix}R / 2.55 \\ G / 2.55 \\ B / 2.55\end{matrix} ] & [ Equation 1 ] \\ var\_X = {( \frac{X}{{X}_{n}} )}^{1 / 3} , \\ for \frac{X}{{X}_{n}} > 0.008856 \\ var\_X = ( 7.787 \times \frac{X}{{X}_{n}} ) + \frac{16}{116} , \\ for \frac{X}{{X}_{n}} \leq 0.008856 \\ var\_Y = {( \frac{Y}{{Y}_{n}} )}^{1 / 3} , \\ for \frac{Y}{{Y}_{n}} > 0.008856 \\ var\_Y ( 7.787 \times \frac{Y}{{Y}_{n}} ) + \frac{16}{116} , \\ for \frac{Y}{{Y}_{n}} \leq 0.008856 \\ var\_Z = {( \frac{Z}{{Z}_{n}} )}^{1 / 3} , \\ for \frac{Z}{{Z}_{n}} > 0.008856 \\ var\_Z = ( 7.787 \times \frac{Z}{{Z}_{n}} ) + \frac{16}{116} , \\ for \frac{Z}{{Z}_{n}} \leq 0.008856 \\ {L}^{*} = ( 116 \times var\_Y ) - 16 \\ {a}^{*} = 500 \times ( Var\_X - var\_Y ) \\ {b}^{*} = 200 \times ( Var\_Y - var\_Z ) \\ where \\ {X}_{n} = 95.047 , {Y}_{n} = 100 , {Z}_{n} = 108.883 & [ Equation 2 ]\end{matrix}$$

The range of the predetermined L*a*b* value may include a plurality of intervals where an area of the a* value and b* the value is determined by each area of the L* value divided into a plurality areas in size order, the plurality of intervals having the a* value and the b* value of a broader area as the L* value is larger.

The range of the predetermined L*a*b* values may be determined as Table 1 below.

TABLE 1

| Interval number | L* value range | a* value range | b* value range |
|---|---|---|---|
| 1 | 99.85 < L* ≦ 100 | all | all |
| 2 | 95 < L* ≦ 99.8 | −18 < a* ≦ 18 | −18 < b* ≦ 18 |
| 3 | 90 < L* ≦ 95 | −18 < a* ≦ 18 | −18 < b* ≦ 18 |
| 4 | 85 < L* ≦ 90 | −16 < a* ≦ 16 | −16 < b* ≦ 16 |
| 5 | 80 < L* ≦ 85 | −14 < a* ≦ 14 | −14 < b* ≦ 14 |
| 6 | 75 < L* ≦ 80 | −12 < a* ≦ 12 | −12 < b* ≦ 12 |
| 7 | 70 < L* ≦ 75 | −10 < a* ≦ 10 | −10 < b* ≦ 10 |
| 8 | 65 < L* ≦ 70 | −9 < a* ≦ 9 | −9 < b* ≦ 9 |
| 9 | 60 < L* ≦ 75 | −8 < a* ≦ 8 | −8 < b* ≦ 8 |
| 10 | 55 < L* ≦ 60 | −7 < a* ≦ 7 | −7 < b* ≦ 7 |
| 11 | 50 < L* ≦ 55 | −6 < a* ≦ 6 | −6 < b* ≦ 6 |
| 12 | 45 < L* ≦ 50 | −5 < a* ≦ 5 | −5 < b* ≦ 5 |
| 13 | 40 < L* ≦ 45 | −4 < a* ≦ 4 | −4 < b* ≦ 4 |
| 14 | 20 < L* ≦ 40 | −3 < a* ≦ 3 | −3 < b* ≦ 3 |

The determining of the pixels to be used for estimating the reference white color may include: determining a plurality of pixels as the pixels to be used for estimating the reference white color, the plurality of pixels being in each interval up to an interval where the accumulated number of pixels in each interval is greater than or equal to the predetermined number of reference samples, starting orderly from an interval where the L*value is larger.

The number of samples may be the minimum 2.5% of the entire number of pixels of the input image.

The determining of the pixels to be used for estimating the reference white color may include: determining the minimum n satisfying Equation 3 below; and determining pixels from a first interval to an nth interval as pixels to be used for estimating the reference white color.

The accumulated number of pixels until nth interval≧the number of reference samples [Equation 3]

The determining of the pixels to be used for estimating the reference white color may include: determining whether the input image is a general input image or a specific input image by respectively comparing the numbers of pixels in the plurality of intervals, the general input image having a uniform brightness distribution in the input image, the specific input image having a partial brightness in the input image; determining a plurality of pixels as the pixels to be used for estimating the reference white color if the input image is the general input image according to the determination result, the plurality of pixels being in each interval up to an interval where the accumulated number of pixels in each interval is greater than or equal to the predetermined number of reference samples, starting orderly from an interval where the L*value is larger; and determining a plurality of pixels as the pixels to be used for estimating the reference white color if the input image is the specific input image according to the determination result, the plurality of pixels in an interval having the largest L* value among the plurality of intervals except for the largest L* value, the interval having the largest L* value where the number of the pixels is greater than the predetermined number of reference samples.

The determining of the pixels may include: comparing a first sum of pixels in intervals having the largest L* value and the second largest L* value with a second sum of pixels in intervals having the third largest L* value and the fourth largest L* value; determining the input image as the general input image if the first sum is less than the second sum, and if the first sum is larger than the second sum, comparing a third sum of intervals having the second largest L* value and the third largest L* value with the number of pixels in the interval having the largest L* value; and determining the input image as the general input image if the third sum is greater than the number of pixels in the interval having the largest L* value and determining the input image as the specific input image if the third sum is less than the number of pixels in the interval having the largest L* value.

The determining of the pixels in the interval having the largest L* value where the number of pixels is greater than the predetermined number of reference samples as the pixels to be used for estimating the reference white color may include again determining the input image as the general input image if there is no interval having the largest L*value where the number of pixels is greater than the predetermined number of reference samples.

The calculating of the color gain may include: setting an average of the L* value and a*=0 and b*=0 of pixels of the input image in a range of the predetermined L*a*b* value assumed that the reference white color is changed as a target value; calculating an approach value to move the reference white color estimation value to the target value; and moving the approach value into the RGB color space.

The calculating of the approach value may include calculating the approach value by applying a Constant Modulus Algorithm (CMA) expressed in Equation 4 below.

$$App\_point = Tar\_point + 2 μ * Ave\_image * ( \begin{matrix}{Tar\_point}^{T} * Ave\_image - \\ \frac{{Tar\_point}^{T} * Ave\_image}{\vert {Tar\_point}^{T} * Ave\_image \vert}\end{matrix} ) \qquad [ Equation 5 ]$$

where App_point is an approach value, Tar_point is a target value, Ave_image is a reference white color estimation value, μ is an arbitrary approach element, and each of the approach value, the target value, and the reference white color estimation value is expressed as a matrix of [L*a*b*].

The moving of the approach value into the RGB color space may include: converting the L*a*b* value that the approach value has into an XYZ value based on the CIE standard; and converting the converted XYZ value of each pixel into an RGB value.

The converting of the L*a*b* value into the XYZ value may be performed through Equation 5 below and the converting of the converted XYZ value into the RGB value may be performed through Equation 6.

$$\begin{matrix}var\_Y = ( {L}^{*} + 16 ) / 116 \\ var\_X = {a}^{*} / 500 = var\_Y \\ var\_Z = var\_Y - {b}^{*} / 200 \\ var1\_Y = {( var\_Y )}^{3} \\ for {( var\_Y )}^{3} > 0.008856 \\ var1\_Y = ( var\_Y - 16 / 116 ) / 7.787 \\ for {( var\_Y )}^{3} \leq 0.008856 \\ var1\_X = {( var\_X )}^{3} \\ for {( var\_X )}^{3} > 0.008856 \\ var1\_X = ( var\_X - 16 / 116 ) / 7.787 \\ for {( var\_X )}^{3} \leq 0.008856 \\ var1\_Z = {( var\_Z )}^{3} \\ for {( var\_Z )}^{3} > 0.008856 \\ var1\_Z = ( var\_Z - 16 / 116 ) / 7.787 \\ for {( var\_Z )}^{3} \leq 0.008856 \\ X = {X}_{n} \times var1\_X / 100 \\ Y = {Y}_{n} \times var1\_Y / 100 \\ Z = {Z}_{n} \times var1\_Z / 100 \\ where \\ {X}_{n} = 95.047 , {Y}_{n} = 100 , {Z}_{n} = 108.883 & [ Equation 5 ] \\ [ \begin{matrix}R \\ G \\ B\end{matrix} ] = [ \begin{matrix}3.2406 & - 1.5372 & - 0.4986 \\ - 0.9686 & 1.8758 & 0.0415 \\ 0.0557 & - 0.2040 & 1.0570\end{matrix} ] \times [ \begin{matrix}X \\ Y \\ Z\end{matrix} ] \times 255 & [ Equation 6 ]\end{matrix}$$

where L*a*b* are an L* value, an a* value, and a b* value of the approach value, X, Y, and Z are an X value, a Y value, and Z value of the converted approach value, and R, G, and B are an R value, a G value, and a B value of the converted approach value.

The calculating of the color gain may include: normalizing the approach value moved into the RGB color space; and determining a reciprocal number of the normalized approach value as a color gain.

The color gain may be determined as Equation 7 below.

$${R}_{gain} = \frac{G}{R} , {G}_{gain} = \frac{G}{G} , {B}_{gain} = \frac{G}{B} \qquad [ Equation 7 ]$$

where Rgain, Ggain, and Bgain represent color gains with respect to an R value, a G value, and a B value of an input image, respectively, and R, G, and B represent an R value, a G value, and a B value of an approach value, respectively.

The method may further include: compensating for a color tone of the input image by applying the calculated color gain to the input image; and repeating the converting of the color space, the determining of the pixels to be used for estimating the reference value, the determining of the reference white color estimation value, the calculating of the color gain, and the compensating of the color tone, by setting the input image having the compensated color tone as a new input image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and other advantages of the present invention will be more clearly understood from the following detailed description taken in conjunction with the accompanying drawings, in which:

FIG. 1 is a flowchart of an auto white balance method according to one embodiment of the present invention;

FIG. 2 is a view illustrating a CIE L*a*b* color space in a three dimension;

FIGS. 3A to 3D and 4A to 4D are views illustrating a gamut of an a* value and a b* value according to an L* value in a CIE L*a*b* color space;

FIGS. 5A and 5B is a view illustrating an area of a* and b* values determined by an L* value; and

FIG. 6 is a flowchart illustrating determining pixels to be used for estimating a reference white color by distinguishing a general input image from a specific input image.

### DETAILED DESCRIPTION OF THE PREFERRED EMBODIMENT

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the figures, the dimensions of layers and regions are exaggerated for clarity of illustration.

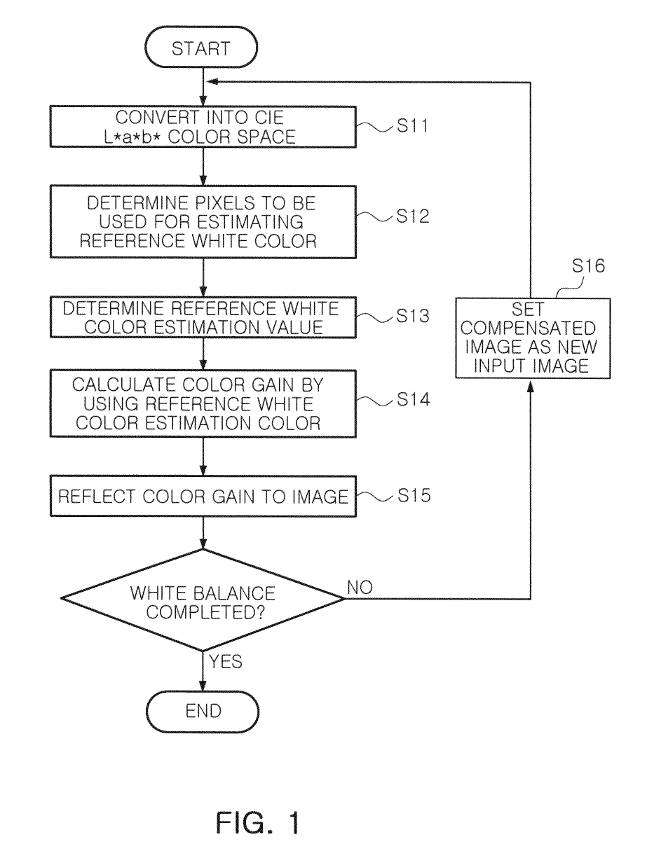

FIG. 1 is a flowchart illustrating an auto white balance method according to one embodiment of the present invention.

As illustrated in FIG. 1, the auto white balance method includes converting a color space of an input image from an RGB color space into the Commission International de I'Eclairage (CIE) L*a*b* color space in operation S11, determining at least a portion of pixels of the input image, assumed that a reference white color is changed, in a range of a predetermined L*a*b* value as pixels to be used for estimating the reference white color in operation S12, determining averages of an L* value, an a* value, a b* value of the determined pixels to be used for estimating the reference white color as a reference white color estimation value in operation S13, and calculating a color gain to move the reference white color estimation value to a target value for a predetermined white balance in operation S14.

Moreover, the auto white balance method further includes compensating for a color tone of the input image by applying the calculated color gain to the input image in operation S15, setting the compensated image as a new input image in operation S16, and then repeating operations S11 through S15.

Hereinafter, each operation in the auto white balance method according to one embodiment of the present invention will be described in more detail.

### Operation S11 for Converting Color Space

One embodiment of the present invention converts a color space of an input image into the CIE L*a*b* color space. In operation S11, red, green, and blue (RGB) values that each pixel of the input image has can be converted into L*, a*, and b* values.

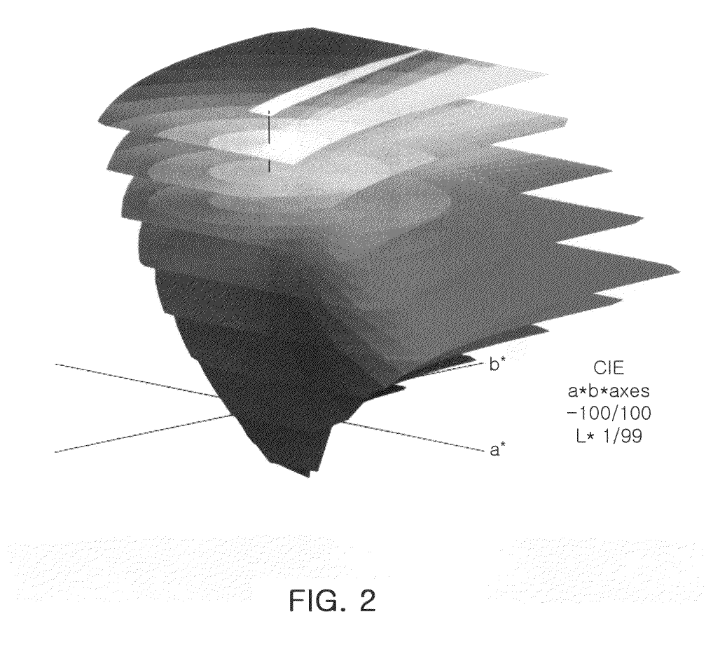

The CIE L*a*b* color space is a color space having features in which chromaticity on a color coordinate is identical to visual chromaticity, and including a vertical plane through L* representing brightness instead of RGB signals as a vertical axis and through a* and b* representing chromaticity as axes. L* has a value ranging from 1 to 100 and, represents a brighter color as its value becomes greater. Using zero as a reference value, a* represents red in a positive (+) direction and green in a negative (−) direction. Additionally, using zero as a reference value, b* represents yellow in a positive (+) direction and blue in a negative (−) direction. This CIE L*a*b* color space is three-dimensionally illustrated in FIG. 2.

The present invention has an advantage in easily understanding visual distribution of an image by converting a color space of an input image into the CIE L*a*b* color space corresponding to visual chromaticity.

To covert the RGB space of an input image into the CIE L*a*b* color space, RGB values of the entire pixels in the input image are converted into XYZ values by using a conversion matrix and then the converted XYX values is converted into the L*a*b* values.

The conversion matrix for XYZ coordinates according to the CIE standard is expressed as the following Equation 1.

$$[ \begin{matrix}X \\ Y \\ Z\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] \times [ \begin{matrix}R / 2.55 \\ G / 2.55 \\ B / 2.55\end{matrix} ] \qquad [ Equation 1 ]$$

In the above Equation 1, by considering that a typical RGB value ranges from 0 through 255, the value 2.55 is a normalized value for a range where an L* value that the CIE L*a*b* color space can have is between 0 and 100. If the RGB value is expressed in another range, the value 2.55 of Equation 1 may be changed according to a range of the RGB value.

To convert the XYZ value obtained through Equation 1 into L*a*b* values, Equation 2 below is used.

$$var\_X = {( \frac{X}{{X}_{n}} )}^{1 / 3} , \\ for \frac{X}{{X}_{n}} > 0.008856 \\ var\_X = ( 7.787 \times \frac{X}{{X}_{n}} ) + \frac{16}{116} , \\ for \frac{X}{{X}_{n}} \leq 0.008856 \\ var\_Y = {( \frac{Y}{{Y}_{n}} )}^{1 / 3} , \\ for \frac{Y}{{Y}_{n}} > 0.008856 \\ var\_Y ( 7.787 \times \frac{Y}{{Y}_{n}} ) + \frac{16}{116} , \\ for \frac{Y}{{Y}_{n}} \leq 0.008856 \\ var\_Z = {( \frac{Z}{{Z}_{n}} )}^{1 / 3} , \\ for \frac{Z}{{Z}_{n}} > 0.008856 \\ var\_Z = ( 7.787 \times \frac{Z}{{Z}_{n}} ) + \frac{16}{116} , \\ for \frac{Z}{{Z}_{n}} \leq 0.008856 \\ {L}^{*} = ( 116 \times var\_Y ) - 16 \\ {a}^{*} = 500 \times ( Var\_X - var\_Y ) \\ {b}^{*} = 200 \times ( Var\_Y - var\_Z ) \\ where \\ {X}_{n} = 95.047 , {Y}_{n} = 100 , {Z}_{n} = 108.883 \qquad [ Equation 2 ]$$

The RGB image signal inputted through the above Equations 1 and 2 is converted into the CIE L*a*b* color space. In the CIE L*a*b* color space, a value (L*=100, a*=0, and b*=0) is the brightest white value (i.e., the reference white value).

### Operation S12 for Determining Pixel to be Used in Estimating Reference White Color

In operation S12, pixels assumed that the reference white color is changed (hereinafter, referred to as an assumed pixel for convenience of explanation) among pixels of an input image, converted into the CIE L*a*b* color space, are determined and a portion or the entire pixels is determined as pixels to be used for estimating a reference white color. These assumed pixels have an L*a*b* value in a range (hereinafter, referred to as an assumed range for convenience of explanation) of the L*a*b* value that is assumed that a reference white color is changed. The assumed range can be determined in advance as follows.

In the CIE L*a*b* color space, because L*=100, a*=0, and b*=0 become coordinates of a reference white color, a pixel of an inputted signal may be assumed as a pixel where a reference white color is changed by a light source as it is closer to L*=100, a*=0, and b*=0. That is, if the pixel is closer to L*=100, a*=0, and b*=0 among pixels of an input image converted to the CIE L*a*b* color space before, there is more possibility that the pixel has an original reference white color. Accordingly, before determining of a a* and b* range according to an L* value that a pixel changed from the reference white color can have, white color is can be estimated using the pixel in the above range. A method of determining the estimated range will be described in more detail as follows.

As mentioned above, an area in an image having the highest possibility that a reference white color is changed by surrounding environments is pixels whose L*, a*, and b* values are closest to the L*=100, a*=0, b*=0. To accurately obtain the pixels closest to the reference white color, if estimating white color with the sufficient number of pixels by arranging all the pixels in the image with priority according to a distance from the reference white color and also selecting L*, a*, and b* values of pixels in a predetermined range (including the reference white color) for white color estimation, it is possible to estimate very accurate white color. However, because it requires complex calculations and calculating systems, this method may be inappropriate in time and economic aspects.

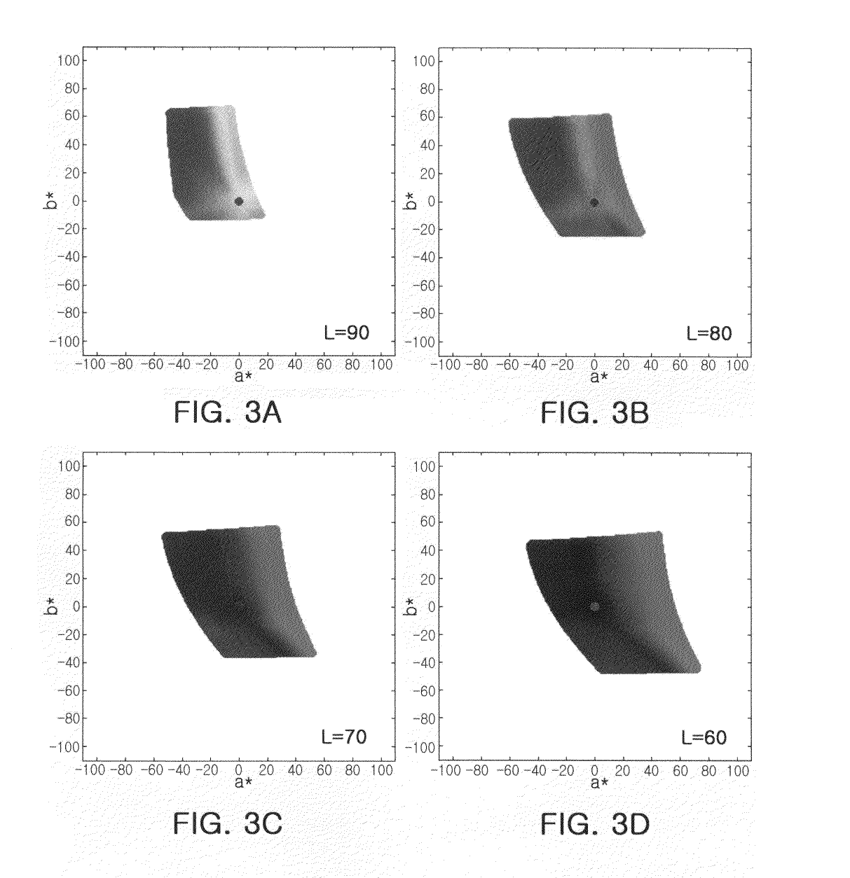

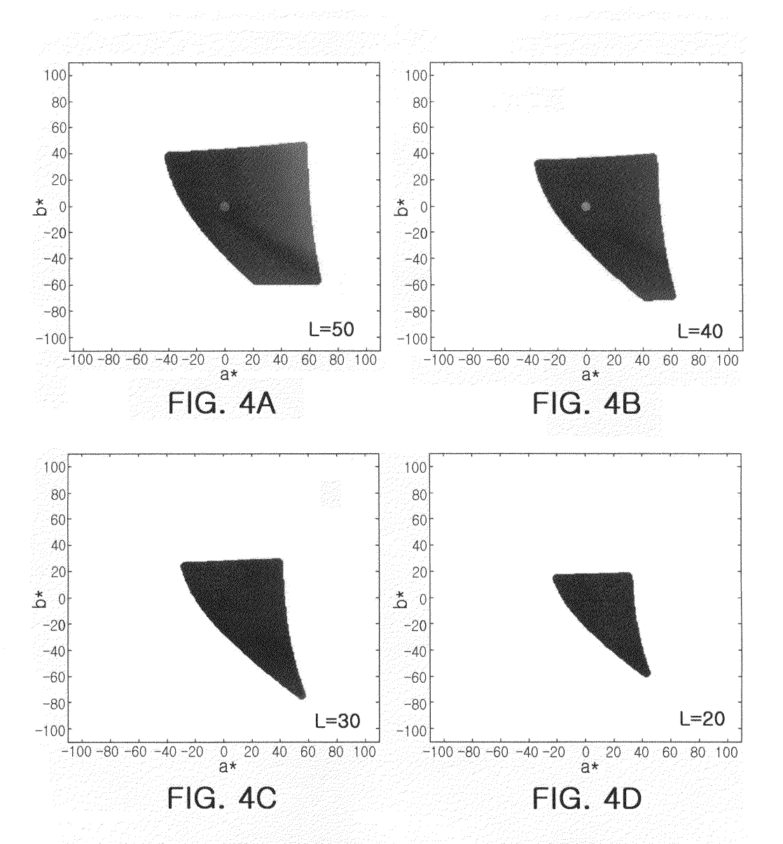

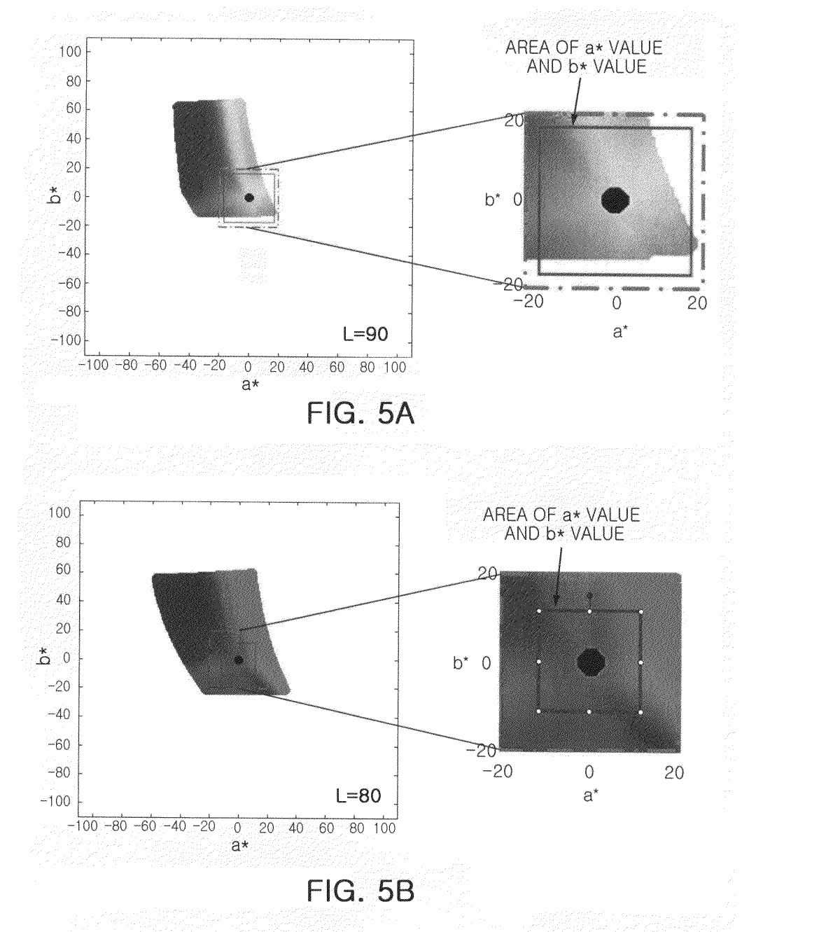

However, referring to gamut according to the L* value as illustrated in FIGS. 3A to 3D and 4A to 4D, a possible area of a* and b* values is determined, where chromaticity of the reference white color is changed and distributed in the L*a*b* color space. While examining the degree of changes of a gray level according to surrounding environments, an amount of changes is larger as it is closer to the reference white color, and its change becomes unnoticeable as it is closer to a dark color. Accordingly, the L* value having a range of 0 to 100 is divided into a plurality of areas according to size, and a* value and b* value are determined by each area of the divided L* value. That is, the estimated range includes a plurality of intervals where areas of a* value and b* value are determined by each area of the L* value divided into a plurality of areas according to size. Moreover, because a range where the reference white color can exist expands as the L* value increases, the area of a* and b* values according to the L* value is broad if the L* value becomes larger and is narrow if the L* value becomes smaller. Through this, because the reference white color can be estimated using all the pixels in an image and pixels having a high probability that the reference white color is changed, processes and systems for estimating the reference white color can be simplified.

As mentioned above, the estimated range of the L*a*b* values, assumed that the reference white color is changed, can be determined as 14 intervals as illustrated in the following Table 1. Table 1 is used for illustrating an exemplary embodiment of the present invention, and the numerical values in the range of Table 1 do not limit the present invention.

TABLE 1

| Interval number | L* value range | a* value range | b* value range |
|---|---|---|---|
| 1 | 99.85 < L* ≦ 100 | all | all |
| 2 | 95 < L* ≦ 99.8 | −18 < a* ≦ 18 | −18 < b* ≦ 18 |
| 3 | 90 < L* ≦ 95 | −18 < a* ≦ 18 | −18 < b* ≦ 18 |
| 4 | 85 < L* ≦ 90 | −16 < a* ≦ 16 | −16 < b* ≦ 16 |
| 5 | 80 < L* ≦ 85 | −14 < a* ≦ 14 | −14 < b* ≦ 14 |
| 6 | 75 < L* ≦ 80 | −12 < a* ≦ 12 | −12 < b* ≦ 12 |
| 7 | 70 < L* ≦ 75 | −10 < a* ≦ 10 | −10 < b* ≦ 10 |
| 8 | 65 < L* ≦ 70 | −9 < a* ≦ 9 | −9 < b* ≦ 9 |
| 9 | 60 < L* ≦ 75 | −8 < a* ≦ 8 | −8 < b* ≦ 8 |
| 10 | 55 < L* ≦ 60 | −7 < a* ≦ 7 | −7 < b* ≦ 7 |
| 11 | 50 < L* ≦ 55 | −6 < a* ≦ 6 | −6 < b* ≦ 6 |
| 12 | 45 < L* ≦ 50 | −5 < a* ≦ 5 | −5 < b* ≦ 5 |
| 13 | 40 < L* ≦ 45 | −4 < a* ≦ 4 | −4 < b* ≦ 4 |
| 14 | 20 < L* ≦ 40 | −3 < a* ≦ 3 | −3 < b* ≦ 3 |

As illustrated in Table 1, in the range of L*a*b* values where the reference white color is changed, it may be regarded that the reference white color of all of the pixels in an interval of 99.8 to 100 is changed by a light source. Additionally, in other intervals, the L* value is divided by a predetermined unit, and an area of a* and b* values applicable to the divided area of each L* value can be appropriately set. Additionally, in an area where the L* value is between 0 to 20, since it is very close to a dark color, there is almost no possibility that the reference white color is changed such that it is unnecessary to fine pixels to be estimated.

On the other hand, when estimating the reference white color, a sufficient amount of samples (i.e., a sufficient amount of pixels for estimating the reference whit color) needs to be prepared in order to minimize errors during a process for estimating the reference white color. For this end, the present invention accumulates numbers in order from pixels in an interval where the L* value is large, selects pixels up to an interval where the accumulated number of pixels is larger than a predetermined ratio of the entire number of pixels of an input image, and then uses the selected pixels for estimating the reference white color. For example, a pixel ratio used for estimating the reference white color can be set with the minimum 2.5% of the entire pixels of an input image. This means that if the input image is 2 M pixel, at least 50,000 pixels are used for estimating the reference white color. For convenience of description, the minimum number of samples according to the predetermined ratio is called a reference sample number.

In Table 1, each interval is assigned with a number in order from the largest L* value. Using the numbers of theses intervals, as illustrated in Equation 8, the accumulated number of pixels can be calculated until each interval.

The accumulated number of pixels_{—}1=the number of pixels in a first interval

The accumulated number of pixels_{—}2=the accumulated number of pixels_{—}1+the number of pixels in a second interval

The accumulated number of pixels_{—}3=the accumulated number of pixels_{—}2+the number of pixels in a third interval

The accumulated number of pixels_{—}4=the accumulated number of pixels_{—}3+the number of pixels in a fourth interval

The accumulated number of pixels_{—}14=the accumulated number of pixels_{—}13+the number of pixels in a fourteenth interval [Equation 8]

where the accumulated number of pixels_k is the number of pixels until a k^{th} interval)

Accumulated pixels until an interval (where the accumulated number of pixels of Equation 8 is greater or equal to the number of reference samples) are used for estimating the reference white color. That is, pixels to be used for estimating the reference white color can be determined by applying Equation 3 below.

The accumulated number of pixels until n^{th} interval≧the number of reference samples [Equation 3]

Once the minimum n is determined to satisfy the above Equation 3, pixels between a first interval and an n^{th} interval can be determined as pixels to be used for estimating the reference white color. For example, if the accumulated number of pixels until a third interval is 2.5% of the number of input image pixels and the accumulated number of pixels until a fourth interval exceeds 2.5% of the number of input image pixels, the accumulated number of pixels until the fourth interval (i.e., the pixels between the first and the fourth intervals) is used for estimating the reference white color. Additionally, if less than the number of reference samples until the fourteenth interval, all the pixels in an entire estimated range may be determined as pixels to be used for estimating the reference white color.

In brief, the determining of the pixels to be used for estimating the reference white color in operation S12 may include selecting pixels in a range of the L*a*b* values assumed that the predetermined reference white color is changed and determining pixels to be used for estimating the reference white color through pixels having more than the predetermined ratio based on the entire input image by accumulating in order from the pixels in an interval having the largest L*.

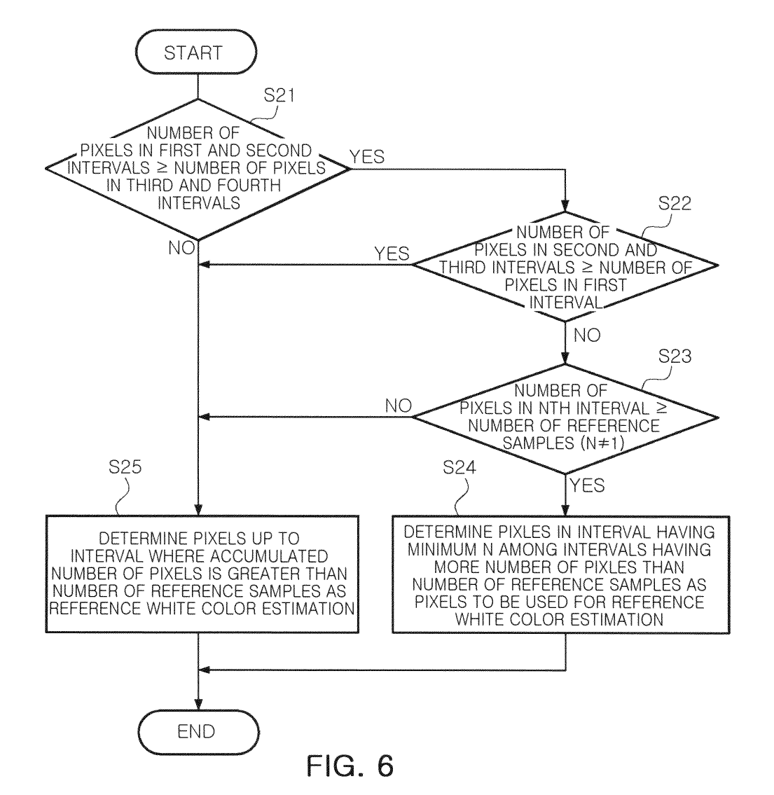

On the other hand, a method of determining pixels to be used for estimating the reference white color can be applied to white balance of a general image (hereinafter, referred as a general input image) having a uniform brightness of an input image. If the method of determining pixels to be used for estimating the reference white color is applied to an input image (hereinafter, referred to as a specific input image) where a specific portion is very bright or a specific color is mostly distributed in a specific portion, an estimated value may be incorrect due to the environmental changes of an input image. Accordingly, the present invention provides an estimated pixel selecting method in order to achieve an accurate reference white color estimation for this specific input image. A method of determining a pixel used for estimating the reference white color by distinguishing the general input image from the specific input image is described in more detail with reference to FIG. 6.

First, as mentioned above, after the determining of the estimated pixels in each interval of the estimated range, a first sum of an interval having the largest L* value and an interval having the second largest L* value and a second sum of an interval having the third largest L* value and an interval having the fourth largest L* value are compared in operation S21. For example, if an interval of the estimated range as illustrated Table 1 is determined, the following Equation 9 can be applied.

The number of pixels in a first interval+the number of pixels in a second interval≧the number of pixels in a third interval+the number of pixels in a fourth interval. [Equation 9]

In the above Equation 9, pixels in the first and second intervals satisfy a range of a color having possibility that the reference white color is changed in a very bright portion. The satisfying of Equation 9 means that there are many pixels in a very bright portion but there are fewer pixels in a relatively dark portion (i.e., third and fourth intervals). That is, this can be determined that there are many pixels in a specific portion of an input image. If it does not satisfy the above Equation 9, because it is determined as a general input image, as mentioned above, pixels in an interval where the accumulated number of pixels is greater than the number of reference samples are determined as pixels to be used for estimating the reference white color in operation S25.

However, even if it satisfies the above Equation 9, it is possible that a specific portion of an image is not bright but the entire image can be bright. In this case, using the same method as the general input image, pixels to be used for estimating reference white color can be determined. To determine whether a specific portion or the entire image is bright in the image satisfying the above Equation 9, a third sum of an interval having the second largest L* value and an interval having the third largest L* value and the number of pixels in an interval having the largest L* value are compared in operation S22. For example, if an interval of the estimated range is determined as illustrated in Table 1, the following Equation 10 can be applied.

The number of pixels in a second interval+the number of pixels in a third interval≧the number of pixels in a first interval [Equation 10]

In a case of satisfying the above Equation 10, it can be determined that the entire image is bright because the number of pixels in the first interval (i.e., the brightest interval) is greater than the number of pixels in the second and third estimated regions, which are darker than the first interval. That is, in the case of satisfying Equation 10, it is determined that an entire image is bright, and then pixels to be used for estimating the reference white color are determined using the same method as the general input image in operation S26.

In a case of satisfying Equation 9 and does not satisfying Equation 10, it is determined as a specific input image finally, and pixels to be uses for estimating the reference white color are determined by applying Equation 11 below in operation S23.

The number of pixels in an n^{th} interval≧the number of reference samples (n≠1) [Equation 11]

That is, in operation S24, pixels in the interval having the minimum n among intervals having the more number of pixels than the number of reference samples are determined as pixels to be used for estimating the reference white color. In this case, the first interval is not included in the comparison target of Equation 11. Because the pixels of the first interval can be determined as pixels in a bright specific portion of an input image, it is to exclude the pixels of the bright specific portion for estimating the reference white estimation. Additionally, if there is no interval satisfying the above Equation 11, the determining of the pixel to be used for estimating the reference white color in operation S25 can be applied

### Operation S13 for Determining Reference White Color Estimation Value

In operation S13, by using the number and values of pixels to be used for estimating reference white color determined in operation S12, a reference white color estimation value can be determined.

In the present invention, the reference white color estimation value can be determined by an average value of the L*a*b* of the pixels to be used for estimating the reference white color. That is, the reference white color estimation value can be determined as the following Equation 12.

L*estimation value=Total_{—}L*_of_selected pixels/Number_of_selected_pixels

a* estimation value=Total_{—}L*_of_selected pixels/Number_of_selected_pixels

b*estimation value=Total_{—}b*_of_selected pixels/Number_of_selected pixels [Equation 12]

In the above Equation 12, Total_L*(a* or b*)_of_selected pixels is the sum of all the L* (a* or b*) values of pixels to be used for estimating the reference white color determined in operation S12, and Number_of_selcted_pixels is the number of pixels to be used for estimating the reference white color determined in operation S12. As shown in the above Equation 12, the L* value for estimating the reference white color is an average of the L* values of pixels to be used for estimating the reference white color determined in operation S12. The a* value for estimating the reference white color estimation is an average of the a* values of pixels to be used for estimating the reference white color determined in operation S12. The b* value for estimating the reference white color estimation is an average of the b* values of pixels to be used for estimating the reference white color determined in operation S12.

### Operation S14 for Calculating Color Gain by Using Reference White Color Estimation Value

In operation S14, a color gain is calculated for moving the reference white color estimation value to an ideal target value by using the white color estimation value calculated as the above Equation. 12.

The white color estimation value calculated the above Equation. 12 may mean that there are color changes by the reference white color estimation value from the ideal value a*=0, b*=0 of an input image. In operation S14, a color gain is calculated to perform white balance by compensating for color changes. In more detail, in operation S14, a color gain for moving the reference white color estimation value of an input image into a target value is calculated by setting an average of the L* values of the entire pixels in an estimated range for white balance and a*=0 and b*=0 as a target value.

Additionally, in operation S14, by considering the possibility that a color of an input image becomes saturated during a white balance process if color gain is too large during the calculating of the color gain for white balance, calculating of a color gain for corresponding to a target value by moving the reference white color estimation value gradually is more desirable than calculating of the color gain by moving from the reference white color estimation value to the target value at once. That is, a compensation method by gradually applying a color gain to an input image is better than a method of compensating for a difference between the reference white color estimation value and a target value at once. An approaching speed for this target value can be adjusted by using an approaching factor. A constant modulus algorithm (CMA) among adjustable signal processing algorithms may be applicable to obtain an Approach_point for moving from the reference white color estimation value to a target value. The CMA is expressed as Equation 13 below, and a weighted vector obtained using this Equation 13 can be used as an element for obtaining a color gain.

$$w ( m + 1 ) = w ( m ) + 2 μ v ( m ) ( \begin{matrix}{w}^{T} ( m ) v ( m ) - \\ \frac{{w}^{T} ( m ) v ( m )}{\vert {w}^{T} ( m ) v ( m ) \vert}\end{matrix} ) \qquad [ Equation 13 ]$$

In the above Equation 13, w is a weight vector, and v is an input signal. By reflecting the above Equation 13, an approach value is obtained to be used for moving the reference white color estimation value to the target value. (m) is an input signal to which an estimation value of an image is applied and w(m) is a target value to which an average of L* values of the entire pixels in an estimated range and a*=0 and b*=0 values are applied. w(m+1) obtained by the above Equation 13 becomes an approach value for moving the reference white color estimation value to a target value for white balance. This approach value can adjust an approaching speed by adjusting the size of an approach element μ. For example, the size of the approach element μ may be 1/32. If the above Equation 13 is applied to the present invention, it is expressed as Equation 4 below.

$$App\_point = Tar\_point + 2 μ * Ave\_image * ( \begin{matrix}{Tar\_point}^{T} * Ave\_image - \\ \frac{{Tar\_point}^{T} * Ave\_image}{\vert {Tar\_point}^{T} * Ave\_image \vert}\end{matrix} ) \qquad [ Equation 4 ]$$

where App_point is an approach value, Tar_point is a target value, and Ave_image is a reference white color estimation value obtained by the above equation 13.

Specifically, the target value is expressed as [L* estimation value 0 0] and the estimation value is expressed as [L* estimation value a* estimation value b* estimation value]. Accordingly, the approach value can be expressed as a form of [L* approach value a*approach value b*approach value].

On the other hand, however an approach value for moving from the reference white color estimation value to the target value can be calculated in the CIE L*a*b* color space as expressed in the above Equation 4. However, because this CIE L*a*b* color space is expressed by separating the brightness from the chrominance, it is inadequate to obtain a color gain for directly compensating for an input image expressed with an RGB value. Accordingly, to determine a color gain, a process for moving an approach value calculated in the L*a*b* color space toward the RGB color space is required.

Similar to the process for the converting of an input image of the RGB color space into the CIE L*a*b* color space in operation S11, the processes for the converting of an L*a*b* value into an XYZ value and then the XYZ value into an RGB value are required. First, Equation 5 below for the converting of the L*a*b* value into the XYZ value is shown.

var_{—}Y=(L*+16)/116

var_{—}X=a*/500+var_{—}Y

var_{—}Z=var_{—}Y−b*/200

var1_{—}Y=(var_{—}Y)³ for (var_{—}Y)³>0.008856

var1_{—}Y=(var_{—}Y−16/116)/7.787 for (var_{—}Y)³≦0.008856

var1_{—}X=(var_{—}X)³ for (var_{—}X)³≧0.008856

var1_{—}X=(var_{—}X−16/116)/7.787 for (var_{—}X)³≦0.008856

var1_{—}Z=(var_{—}Z)³ for (var_{—}Z)³>0.008856

var1_{—}Z=(var_{—}Z−16/116)/7.787 for (var_{—}Z)³≦0.008856

X=Xₙ×var1_{—}X/100

Y=Yₙ×var1_{—}Y/100

Z=Zₙ×var1_{—}Z/100 [Equation 5]

where Xₙ=95.047, Yₙ=100, Zₙ=108.883

Additionally, the converting of the XYZ value into the RGB value can be expressed as Equation 6 below.

$$[ \begin{matrix}R \\ G \\ B\end{matrix} ] = [ \begin{matrix}3.2406 & - 1.5372 & - 0.4986 \\ - 0.9686 & 1.8758 & 0.0415 \\ 0.0557 & - 0.2040 & 1.0570\end{matrix} ] \times [ \begin{matrix}X \\ Y \\ Z\end{matrix} ] \times 255 \qquad [ Equation 6 ]$$

The constant number 100 used in multiplication in the last three Equations of Equation 5 and the constant number 255 of Equation 6 are used for converting the RGB value into the values having a range of 0 to 255.

If the R value, G value, and B value are the same, it becomes one of gray levels having no color. The ratio of the RGB value of the approach value obtained through Equation 6 means that an input image is biased to a corresponding color by that much ratio. A white balance process is required for compensating for that much ratio. Accordingly, if the reciprocal number of the ratio is multiplied to an image, white balance can be performed. Accordingly, a reciprocal number of the ratio for white balance can be determined as a color gain for white balance. To calculate a color gain, the G value is normalized as a standard to allow the RGB value of the approach value calculated using the above Equation 6 to be identical to each other, and its reciprocal number is determined as a color gain for white balance of an input image. That is, this color gain can be obtained using the following Equation 7.

$${R}_{gain} = \frac{G}{R} , {G}_{gain} = \frac{G}{G} , {B}_{gain} = \frac{G}{B} \qquad [ Equation 7 ]$$

where R_{gain}, G_{gain}, and B_{gain} represent color gains with respect to an R value, a G value, and a B value of an input image, respectively, and R, G, and B represent an R value, a G value, and a B value of an approach value, respectively.

The color gain calculated using the above Equation 7 applies Rgain, Ggain, and Bgain to the R value, G value, and the B value, respectively, such that white balance can be performed.

The approach value does not complete white balance at once, but is used for gradually moving the estimation value to the target value. Thus, an image obtained by applying the Rgain, the Ggain, and the Bgain to the R value, G value, and the B value of each of the entire pixels of the input image, respectively, is set as a new input image again such that operations S11 to S14 repeat to achieve more accurate white balance.

According to the present invention, by moving an input image into the CIE L*a*b* color space (where actual chrominance and visual chrominance are identical) for estimating the reference white color, a reference white color identical to human vision can be estimated such that more natural auto white balance can be achieved.

Additionally, by comparing the number of pixels in a plurality of intervals according to L*, a*, and b* to classify images, even if a specific portion of an image is extremely bright or specific colors are greatly distributed, accurate white balance can be achieved.

Moreover, because only the pixels in an estimation range (where it is assumed that the reference white color is changed) instead of the entire pixels of an image for white balance are calculated, it is possible to realized with a simple hardware without complex calculation such that it can be applied to a mobile phone or personal digital assistant (PDA) having a micro digital camera device.

While the present invention has been shown and described in connection with the exemplary embodiments, it will be apparent to those skilled in the art that modifications and variations can be made without departing from the spirit and scope of the invention as defined by the appended claims.

What is claimed is:

1. An auto white balance method comprising:
converting a color space of an input image from an RGB color space into the Commission International de I'Eclairage (CIE) L*a*b* color space;
determining at least a portion of pixels of the input image, assumed that a reference white color is changed, in a range of a predetermined L*a*b* value as pixels to be used for estimating the reference white color;
determining averages of an L* value, an a* value, a b* value of the determined pixels to be used for estimating the reference white color as a reference white color estimation value; and
calculating a color gain to move the reference white color estimation value to a target value for a predetermined white balance.

2. The method of claim 1, wherein the converting of the color space comprises:
converting an RGB value that each pixel of the input image has into an XYZ value based on the CIE standard; and
converting the converted XYZ value of each pixel into the L*a*b* value.

3. The method of claim 2, wherein the converting of the RGB value into the XYZ value is performed through Equation 1 below and the converting of the XYZ value into the L*a*b* value is performed through Equation 2 below.
$$\begin{matrix}[ \begin{matrix}X \\ Y \\ Z\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] \times [ \begin{matrix}R / 2.55 \\ G / 2.55 \\ B / 2.55\end{matrix} ] & [ Equation 1 ] \\ var\_X = {( \frac{X}{{X}_{n}} )}^{1 / 3} , \\ for \frac{X}{{X}_{n}} > 0.008856 \\ var\_X = ( 7.787 \times \frac{X}{{X}_{n}} ) + \frac{16}{116} , \\ for \frac{X}{{X}_{n}} \leq 0.008856 \\ var\_Y = {( \frac{Y}{{Y}_{n}} )}^{1 / 3} , \\ for \frac{Y}{{Y}_{n}} > 0.008856 \\ var\_Y ( 7.787 \times \frac{Y}{{Y}_{n}} ) + \frac{16}{116} , \\ for \frac{Y}{{Y}_{n}} \leq 0.008856 \\ var\_Z = {( \frac{Z}{{Z}_{n}} )}^{1 / 3} , \\ for \frac{Z}{{Z}_{n}} > 0.008856 \\ var\_Z = ( 7.787 \times \frac{Z}{{Z}_{n}} ) + \frac{16}{116} , \\ for \frac{Z}{{Z}_{n}} \leq 0.008856 \\ {L}^{*} = ( 116 \times var\_Y ) - 16 \\ {a}^{*} = 500 \times ( Var\_X - var\_Y ) \\ {b}^{*} = 200 \times ( Var\_Y - var\_Z ) \\ where \\ {X}_{n} = 95.047 , {Y}_{n} = 100 , {Z}_{n} = 108.883 & [ Equation 2 ]\end{matrix}$$

4. The method of claim 1, wherein the range of the predetermined L*a*b* value comprises a plurality of intervals where an area of the a* value and b* the value is determined by each area of the L* value divided into a plurality areas in size order, the plurality of intervals having the a* value and the b* value of a broader area as the L* value is larger.

5. The method of claim 4, wherein the range of the predetermined L*a*b* values is determined as Table 1 below.
TABLE 1

| Interval number | L* value range | a* value range | b* value range |
|---|---|---|---|
| 1 | 99.85 < L* ≦ 100 | all | all |
| 2 | 95 < L* ≦ 99.8 | −18 < a* ≦ 18 | −18 < b* ≦ 18 |
| 3 | 90 < L* ≦ 95 | −18 < a* ≦ 18 | −18 < b* ≦ 18 |
| 4 | 85 < L* ≦ 90 | −16 < a* ≦ 16 | −16 < b* ≦ 16 |
| 5 | 80 < L* ≦ 85 | −14 < a* ≦ 14 | −14 < b* ≦ 14 |
| 6 | 75 < L* ≦ 80 | −12 < a* ≦ 12 | −12 < b* ≦ 12 |
| 7 | 70 < L* ≦ 75 | −10 < a* ≦ 10 | −10 < b* ≦ 10 |
| 8 | 65 < L* ≦ 70 | −9 < a* ≦ 9 | −9 < b* ≦ 9 |
| 9 | 60 < L* ≦ 75 | −8 < a* ≦ 8 | −8 < b* ≦ 8 |
| 10 | 55 < L* ≦ 60 | −7 < a* ≦ 7 | −7 < b* ≦ 7 |
| 11 | 50 < L* ≦ 55 | −6 < a* ≦ 6 | −6 < b* ≦ 6 |
| 12 | 45 < L* ≦ 50 | −5 < a* ≦ 5 | −5 < b* ≦ 5 |
| 13 | 40 < L* ≦ 45 | −4 < a* ≦ 4 | −4 < b* ≦ 4 |
| 14 | 20 < L* ≦ 40 | −3 < a* ≦ 3 | −3 < b* ≦ 3 |

6. The method of claim 4, wherein the determining of the pixels to be used for estimating the reference white color comprises: determining a plurality of pixels as the pixels to be used for estimating the reference white color, the plurality of pixels being in each interval up to an interval where the accumulated number of pixels in each interval is greater than or equal to the predetermined number of reference samples, starting orderly from an interval where the L*value is larger.

7. The method of claim 6, wherein the number of samples is the minimum 2.5% of the entire number of pixels of the input image.

8. The method of claim 5, wherein the determining of the pixels to be used for estimating the reference white color comprises:
determining the minimum n satisfying Equation 3 below; and
determining pixels from a first interval to an n^{th} interval as pixels to be used for estimating the reference white color.
The accumulated number of pixels until n^{th} interval≧the number of reference samples [Equation 3]

9. The method of claim 4, wherein the determining of the pixels to be used for estimating the reference white color comprises:
determining whether the input image is a general input image or a specific input image by respectively comparing the numbers of pixels in the plurality of intervals, the general input image having a uniform brightness distribution in the input image, the specific input image having a partial brightness in the input image;
determining a plurality of pixels as the pixels to be used for estimating the reference white color if the input image is the general input image according to the determination result, the plurality of pixels being in each interval up to an interval where the accumulated number of pixels in each interval is greater than or equal to the predetermined number of reference samples, starting orderly from an interval where the L*value is larger; and
determining a plurality of pixels as the pixels to be used for estimating the reference white color if the input image is the specific input image according to the determination result, the plurality of pixels in an interval having the largest L* value among the plurality of intervals except for the largest L* value, the interval having the largest L* value where the number of the pixels is greater than the predetermined number of reference samples.

10. The method of 9, wherein the determining of the pixels comprises:
comparing a first sum of pixels in intervals having the largest L* value and the second largest L* value with a second sum of pixels in intervals having the third largest L* value and the fourth largest L* value;
determining the input image as the general input image if the first sum is less than the second sum, and if the first sum is larger than the second sum, comparing a third sum of intervals having the second largest L* value and the third largest L* value with the number of pixels in the interval having the largest L* value; and
determining the input image as the general input image if the third sum is greater than the number of pixels in the interval having the largest L* value and determining the input image as the specific input image if the third sum is less than the number of pixels in the interval having the largest L* value.

11. The method of claim 9, wherein the determining of the pixels in the interval having the largest L* value where the number of pixels is greater than the predetermined number of reference samples as the pixels to be used for estimating the reference white color comprises again determining the input image as the general input image if there is no interval having the largest L*value where the number of pixels is greater than the predetermined number of reference samples.

12. The method of claim 1, wherein the calculating of the color gain comprises:
setting an average of the L* value and a*=0 and b*=0 of pixels of the input image in a range of the predetermined L*a*b* value assumed that the reference white color is changed as a target value;
calculating an approach value to move the reference white color estimation value to the target value; and
moving the approach value into the RGB color space.

13. The method of claim 12, wherein the calculating of the approach value comprises calculating the approach value by applying a Constant Modulus Algorithm (CMA) expressed in Equation 4 below.
$$App\_point = Tar\_point + 2 μ * Ave\_image * ( \begin{matrix}{Tar\_point}^{T} * Ave\_image - \\ \frac{{Tar\_point}^{T} * Ave\_image}{\vert {Tar\_point}^{T} * Ave\_image \vert}\end{matrix} ) \qquad [ Equation 4 ]$$
where App_point is an approach value, Tar_point is a target value, Ave_image is a reference white color estimation value, μ is an arbitrary approach element, and each of the approach value, the target value, and the reference white color estimation value is expressed as a matrix of [L*a*b*]

14. The method of claim 12, wherein the moving of the approach value into the RGB color space comprises:
converting the L*a*b* value that the approach value has into an XYZ value based on the CIE standard; and
converting the converted XYZ value of each pixel into an RGB value.

15. The method of claim 14, wherein the converting of the L*a*b* value into the XYZ value is performed through Equation 5 below and the converting of the converted XYZ value into the RGB value is performed through Equation 6.
$$\begin{matrix}var\_Y = ( {L}^{*} + 16 ) / 116 \\ var\_X = {a}^{*} / 500 = var\_Y \\ var\_Z = var\_Y - {b}^{*} / 200 \\ var1\_Y = {( var\_Y )}^{3} \\ for {( var\_Y )}^{3} > 0.008856 \\ var1\_Y = ( var\_Y - 16 / 116 ) / 7.787 \\ for {( var\_Y )}^{3} \leq 0.008856 \\ var1\_X = {( var\_X )}^{3} \\ for {( var\_X )}^{3} > 0.008856 \\ var1\_X = ( var\_X - 16 / 116 ) / 7.787 \\ for {( var\_X )}^{3} \leq 0.008856 \\ var1\_Z = {( var\_Z )}^{3} \\ {for ( var\_Z )}^{3} > 0.008856 \\ var1\_Z = ( var\_Z - 16 / 116 ) / 7.787 \\ {for ( var\_Z )}^{3} \leq 0.008856 \\ X = {X}_{n} \times var1\_X / 100 \\ Y = {Y}_{n} \times var1\_Y / 100 \\ Z = {Z}_{n} \times var1\_Z / 100 \\ where \\ {X}_{n} = 95.047 , {Y}_{n} = 100 , {Z}_{n} = 108.883 & [ Equation 5 ] \\ [ \begin{matrix}R \\ G \\ B\end{matrix} ] = [ \begin{matrix}3.2406 & - 1.5372 & - 0.4986 \\ - 0.9686 & 1.8758 & 0.0415 \\ 0.0557 & - 0.2040 & 1.0570\end{matrix} ] \times [ \begin{matrix}X \\ Y \\ Z\end{matrix} ] \times 255 & [ Equation 6 ]\end{matrix}$$
where L*a*b* are an L* value, an a* value, and a b* value of the approach value, X, Y, and Z are an X value, a Y value, and Z value of the converted approach value, and R, G, and B are an R value, a G value, and a B value of the converted approach value.

16. The method of claim 12, wherein the calculating of the color gain comprises:
normalizing the approach value moved into the RGB color space; and
determining a reciprocal number of the normalized approach value as a color gain.

17. The method of claim 16, wherein the color gain is determined as Equation 7 below.
$${R}_{gain} = \frac{G}{R} , {G}_{gain} = \frac{G}{G} , {B}_{gain} = \frac{G}{B} \qquad [ Equation 7 ]$$
where R_{gain}, G_{gain}, and B_{gain} represent color gains with respect to an R value, a G value, and a B value of an input image, respectively, and R, G, and B represent an R value, a G value, and a B value of an approach value, respectively.

18. The method of claim 1, further comprising:
compensating for a color tone of the input image by applying the calculated color gain to the input image; and
repeating the converting of the color space, the determining of the pixels to be used for estimating the reference value, the determining of the reference white color estimation value, the calculating of the color gain, and the compensating of the color tone, by setting the input image having the compensated color tone as a new input image.
